(19) United States
(12) Patent Application Publication
(10) Pub. No.: US 2013/0305378 A1
(43) Pub. Date: Nov. 14, 2013

(54) METHOD AND SYSTEM FOR ESTABLISHING TRUST BETWEEN A SERVICE PROVIDER AND A CLIENT OF THE SERVICE PROVIDER

(71) Applicants: Matthew JOHNSON, Luton (GB); Malcolm LEWIS, Twickenham (GB); Boris TARATINE, London (GB)

(72) Inventors: Matthew JOHNSON, Luton (GB); Malcolm LEWIS, Twickenham (GB); Boris TARATINE, London (GB)

(73) Assignee: VISA EUROPE LIMITED, London (GB)

(21) Appl. No.: 13/467,862

(22) Filed: May 9, 2012

(51) Int. Cl. G06F 21/00

(52) U.S. Cl. 726/26

(57) ABSTRACT

Trust is established between a service provider (20) and a client (10) of the service provider (20). The client (10) is associated with a party that is known by an identity provider (50), and the identity provider (50) is trusted by the service provider (20). The identity provider (50) contacts (70) the party (80) via a predetermined medium, and requests the party to identify itself. The identity provider (50) determines whether the identity of the identifying party (80) corresponds to an identity held by the identity provider (50) for the party and shares a secret (100) with the identifying party (80) in the event that the identity provider (50) has determined that the identity of the identifying party (80) is the same as said identity held by the identity provider (50).

### BACKGROUND

1. Field of the Invention

The present application relates to a method and system for establishing trust between a service provider and a client of the service provider.

2. Description of the Related Technology

Identity theft is a relatively common occurrence in the present day. It is possible, for example, to purchase personal details of another person over the internet, which may be sufficient to gain access to services using that person's identity. Such details may be sufficient, for example, to open up a bank account or claim state benefits in a person's name, or to make payments from a person's bank account etc. As many services are now provided without face-to-face contact (over the internet, for example), it is ever more difficult to spot identity theft.

As a particular example, online merchants who sell products or services from an internet site often provide online payment services. However, many such payment services have minimal security, and it is possible to purchase products and/or services from an online merchant by simply providing credit card details, a name and an address; all of which can be easily bought online. A true account holder, whose details have been stolen and used fraudulently, can repudiate the fraudulent payment, by claiming against the payment, causing an online merchant to lose money if the services/products have already been provided/dispatched. As the range of personal identifiable information that can be bought online increases, more stringent measures need to be taken to verify that a client providing account details for payment to an online merchant is actually authorized to use that account.

There is also a need to establish a level of trust between a service provider and a client of a service provider outside the field of monetary transactions. For example, a client may attempt to enroll a party with a service provider (such as a university, for example), and it may be important that the service provider knows the client is authorized by the party to enroll that party.

A system and method for establishing a level of trust between a service provider (in this case an online merchant) and a client of the service provider is described in US A 2002/0138450. With this system, the client is an application running on a device used by a user; the client contacts a service provider via a first communication network and provides details that uniquely identify a party (for example bank account details, which identify an account holder). These details may relate to a party that is the actual owner and authorized user of the device, or, in the case that the details have been stolen, to another party, who is not authorized to use the details. Thus, at this stage, the service provider simply knows that there is an association of sorts between the party using the device and the client application running on the device being used to submit the details. Importantly, the service provider does not trust that the client is authorized to use the submitted details.

In order to verify the association between the party using the device and the client thereon, the service provider sends the details to an identity provider that can validate the identity of the party who submitted the details. Such an identity provider could, for example, be an issuing bank. On the basis of records held by the identity provider for the party corresponding to the submitted details, the identity provider then determines an address of a second device on a second communication network, which it knows to be associated with the party that owns the details submitted via the client, and sends a secret number to that second device.

If the user of the first device is also in possession of the second device, they can receive the secret number on the second device and then supply the secret number to the client so that the secret number can be sent from the first device to the service provider in order to verify the payment. Upon receipt of a secret number, the service provider then sends the secret number to the identity provider so that the identity provider can check whether the number received from the client matches the number sent to the second device. If the numbers match, the identity provider indicates to the service provider that the service provider can trust the client. However, if the numbers do not match, the identity provider indicates to the service provider that the client should not be trusted.

It will be appreciated that, in the case that the user of the first device has both stolen the details of a party and also has access to messages sent to the second device, the user of the device can obtain access to the secret number via the second device and can provide this secret to the client, thus providing the user of the device with access to services provided by the service provider using the personal details of the party who actually owns the submitted details.

### SUMMARY

According to a first aspect of the present invention, there is provided a method of establishing trust between a service provider and a client of the service provider, the client being associated with a party known by an identity provider that is trusted by the service provider, and said identity provider using a predetermined medium to contact said party, the method comprising: contacting the party via said predetermined medium, whereby to request the party to identify itself to the identity provider; determining, up to a predetermined level of trust, whether the identity of the identifying party corresponds to an identity held by the identity provider for the party; sharing a first secret with the party in the event that the identity provider has determined that the identity of the identifying party is the same as said identity held by the identity provider, said first secret being for use by the client in establishing trust between the client and the service provider.

Thus according to exemplary embodiments described herein, unlike the aforementioned prior art system, the identity provider does not share the first secret with the contacted party straight away. Instead, the identity provider determines, up to a predetermined level of trust, whether the identity of the identifying party corresponds to the identity of the party associated with the client and does not share the first secret with the identifying party if it does not trust that the identifying party is the party associated with the client. This prevents fraudsters who have somehow gained access to the predetermined contact medium (between the identity provider and the party) from retrieving the first secret, and also allows fraudsters to be detected if they are unable to prove to the identity provider that the purported association with the client is valid.

In exemplary embodiments, the service provider may be an online merchant, which provides access to transaction and payment services, and the client may be a program or application on a device. The client may request a transaction to be made by the online merchant from the account of the party associated with the client. The service provider needs to determine whether to trust that the client is authorized to request a transaction on behalf of the party with which it purports to have an association. The identity provider, in this case, may be an issuing bank with which the associated party holds an account. The issuing bank has access to data identifying a predetermined medium for contacting that party and data that enables the bank to determine, up to a predetermined level of trust, whether an identifying party is the known party.

In an embodiment, the method may further comprise receiving data that uniquely identifies the party, and using this data to identify both the identity of the party and said predetermined medium for contacting the party.

Conveniently, the method may further comprise identifying said predetermined medium from a storage device accessible by the identity provider, said storage device storing associations between said party and at least one communication medium previously agreed between the identity provider and said party.

In one arrangement, in the event that the identity provider verifies that the identity of the identifying party does not correspond to an identity held by the identity provider for the party, then the identity provider indicates to the service provider that verification was unsuccessful. This allows the service provider to block services to a device on which the untrusted client is run/that is used by the untrusted client.

Advantageously, the party may be known by a plurality of identity providers, each of which is trusted by the service provider and in which, in the event that each said identity provider independently determines that the identity of the identifying party corresponds to the identity of the party, each of said identity providers shares a different first secret with the party, each said different first secret being for use by the client in establishing trust between the client and the service provider. The greater the number of identity providers used by the service provider, the higher the level to which the service provider can trust the client.

In one embodiment, the data is sufficient for the party to be identified by the identity provider, but may be insufficient for a transaction to be carried out using the data. Therefore, if the data is intercepted, it cannot be used fraudulently.

In one arrangement, the step of determining whether the identity of the identifying party corresponds to an identity held by the identity provider for the party may be dependent upon the identifying party identifying itself in accordance with a predetermined set of authentication criteria. The authentication criteria may include, for example, requiring that the identifying party identifies itself using a second predetermined medium that has been pre-agreed between the identity provider and the party associated with the client and may additionally/alternatively require that the identifying party can correctly answer a number of questions, the answers to which are only known by the identity provider and the party associated with the client.

Conveniently, for each identity provider, the method may further comprise sharing a second secret unique to that identity provider between that identity provider and the service provider for the party via a secure channel. Such a secure channel may be provided, for example, using cryptography. The service provider can, therefore, determine whether to trust the client based on whether the client can provide a secret to the service provider that corresponds to this second secret.

In one arrangement, trust may be established between the client and the service provider in dependence upon the first secret for each identity provider matching the second secret for that identity provider.

Advantageously, at least one identity provider may send data relating to the party to the service provider, said data being required by the service provider to provide a service to the client. In general, the client will send details identifying the party associated with the client to the service provider, but in this case, the client only needs to send details that are sufficient to identify the party to the identity provider, and does not need to provide all the details that are required by the service provider. Such details may be, for example, the postcode of the party, the first and last digits of the account number of an account held by the party, and the day of birth of the party. This, therefore, reduces the risk that if details sent from the client to the service provider are intercepted, they can be used fraudulently.

Conveniently, for each identity provider, the first secret for that identity provider may be shared with the party contacted by that identity provider via a secure channel. The secure channel may be provided, for example, using cryptography.

According to a second aspect of the present invention, there is provided a method of establishing trust between a service provider and a client of the service provider, the client being associated with a party known by an identity provider that is trusted by the service provider, said identity provider using a predetermined medium to contact said party thereby requesting said party to identify itself and, in the event of the identity provider determining up to a predetermined level of trust that the identity of the identifying party corresponds to the identity of said party, said identity provider sharing a first secret with said party, the method comprising: sharing a second secret with the identity provider; and, responsive to receipt of a secret from the client, determining whether the secret received from the client matches said second secret; and, in the event that the secret received from the client matches said second secret, determining to trust said client.

In this embodiment, the service provider trusts that the identity provider has determined that the contacted party is the party associated with the client before it shared a first secret with that party. Therefore, if the service provider receives a secret from the client that corresponds to the second secret (and which the service provider knows corresponds to the first secret), then the service provider can be confident that the client is authorized, by the party associated with the client, to request a service on behalf of the party with which the client is associated. In other words, the service provider can trust the association between the client and the associated party (i.e. the party that is associated with the client 10).

In one arrangement, the method may further comprise receiving data from the client that uniquely identifies the party and sending said data to the identity provider. When the service provider receives data from a client that identifies a party, the service provider forms an untrusted association between the party and the client.

Advantageously, the client may be further associated with a device and, in the event that a secret that matches said second secret is received from the client in association with data that uniquely identifies a said device, the method further comprises: determining whether the device identified by said data corresponds to said associated device; and, in the event that the device identified by said data corresponds to said associated device, binding the identity of the device to the identity of said party. The client may be associated with a device if the client is an application or program run on that device, or alternatively, the client may be associated with a device that is used by the client. If the service provider binds the identity of the device to a party, and if the client later requests services from the service provider on behalf of the associated party via that device, the service provider may trust that the client is authorized to request services on behalf of the associated party This may mean that the party associated with the device can easily access services from the service provider using their device without having to prove their identity.

Conveniently, in the event that a message is received from the identity provider that indicates that the identity provider was unable to verify the identity of the party, further services with said device are blocked. This prevents a fraudster from repeatedly trying to fraudulently use someone's identity.

According to a third aspect of the present invention, there is provided a system for use in establishing trust between a service provider and a client of the service provider, the system comprising: a service provider computing system; and a proxy computing system associated with a proxy acting for the service provider, said proxy being trusted by the service provider and said client being associated with a party that is known by the proxy, wherein said proxy computing system is arranged to contact said party using a predetermined medium, the proxy computing system being arranged to: contact the party via said predetermined medium, whereby to request the party to identify itself to the proxy; determine, up to a predetermined level of trust, whether the identity of the identifying party corresponds to an identity held by proxy for the party; and responsive to a determination that the identity of the identifying party corresponds to said identity held by the proxy, share a first secret with the party, and responsive to receipt of a secret from the client, the service provider computing system is arranged to determine whether the secret received from the client matches said first secret, and, in the event that the secret received from the client is determined to match the first secret, the service provider computer system is arranged to configure a level of trust in respect of said client for the service provider.

An identity provider used by the service provider can be considered to act as a proxy for the service provider, because the identity provider effectively validates, on behalf of the service provider, the purported association between the client and the party using the client.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows schematically an example of an embodiment of the present invention;

FIG. 2 shows schematically an example of an alternative embodiment of the present invention;

FIG. 3 shows schematically a particular example of the embodiment of FIG. 2 in which, the service provider is an online merchant and the identity provider is a bank;

FIG. 4 shows schematically a time flow diagram of the example shown in FIG. 3;

FIG. 5 shows schematically a further example of an embodiment of the present invention in which, the service provider is an online merchant and the identity provider is a bank;

FIG. 6 shows schematically a further example of an embodiment of the present invention in which, there are two identity providers; and,

FIG. 7 shows schematically components of exemplary computing devices configured to execute any of the exemplary embodiments as described herein.

### DETAILED DESCRIPTION OF CERTAIN INVENTIVE EMBODIMENTS

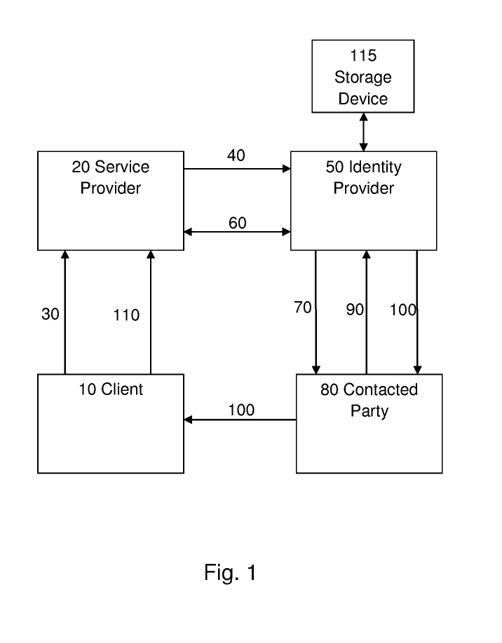

Embodiments of the invention are concerned with providing a process for determining whether a service provider should trust a client of a service provider. FIG. 1 illustrates an operating environment within which, exemplary embodiments may be practiced. In this environment, a client 10 of a service provider 20 may request a service from a service provider 20 on behalf of a party. The client 10 may, for example, be an application or program running on a device, and in general, the user of the device will be using the client 10 to indirectly request the service, via the client 10.

As discussed above, prior art methods and systems do not provide adequate methods for ensuring that the client 10 is authorized to request services on behalf of the party. As an example, the service provider 20 may be an online merchant, and the client 10 may request the merchant 20 to carry out a monetary transaction on behalf of a party. In this case, it is important that the service provider 20 can trust that the client 10 is authorized to request a monetary transaction on behalf of the party. In particular, in the case that the client 10 is an application running on a device, it may be that the user of the device is attempting to fraudulently use the details of the party via the client 10 in order to carry out a transaction. It is important that the service provider 20 can spot such fraudulent activity.

In one embodiment, as illustrated in FIG. 1, in order to access services provided by a service provider 20 on behalf of a party, the client 10 sends details 30 to the service provider 20 that uniquely identify the party. In other words, the client 10 claims to be associated with a party that is using the client 10. These details 30 may, for example, include details such as the name of the party, details of a bank account held by the party, a contact address for the party, or any other information that may uniquely identify a party. In the present example, the details 30 are sufficient for the service provider 20 to provide services to the client 10 (in the event that the service provider determines to trust that the client 10 is the party identified in the details).

Upon receipt of the details 30 from the client 10, the service provider 20 forms an association between the client 10 and the party. At this stage, however, the service provider 20 does not trust that the association between the client 10 and the party is valid. In other words, the service provider 20 does not trust that the client 10 is authorized to request a service on behalf of the party and therefore, at this stage of the process, the association is an untrusted association. In order for the service provider 20 to verify whether the client 10 is authorized to request a service on behalf of the party, the service provider 20 sends data 40 containing information that uniquely identifies the party to an identity provider 50. The identity provider 50 is an entity that both knows the party that is associated with the client 10 and is trusted by the service provider 20. The identity provider 50 may, for example, be a bank with which the party holds an account.

In one example, the data 40 that uniquely identifies the party is sufficient to identify the party to the identity provider 50, but is insufficient for a transaction to be carried out using the data 40, or for the identity of the party to be fraudulently used in any other way. In other words, if the data 40 were to be intercepted, it could not be used to carry out a transaction or to fraudulently use the identity of the party identified in the data.

Once the identity provider 50 has received the details 40 relating to the party associated with the client 10 from the service provider 20, the identity provider then uses this data 40 to identify the identity of the party. At some later time, a secret 60, that is unique to the party, is shared between the service provider 20 and the identity provider 50 via a secure channel. The secret may be, for example, a number or a password comprising numbers, letters and symbols and may, for example, be randomly generated. As another example, the secret could be made up of cryptographic material. In this case, the identity provider 50 and the service provider 20 would both hold a pre-agreed encryption key and/or would use a pre-agreed cryptographic protocol. In this case, the secure channel is provided by encryption. In this example, it has been pre-agreed between the service provider 20 and the identity provider 50 whether the service provider 20 will generate the secret 60 and then send it to the identity provider 50 or whether the identity provider 50 will generate the secret 60 and then send it to the service provider 20. The service provider 20 and the identity provider 50 each store an association between the secret 60 and the party associated with the client 10 in a storage device. In a preferred embodiment, the secret 60 is generated by the service provider 20 in a format that is preferred by the service provider 20. This ensures that, if the service provider 20 can use any of a plurality of identity providers 50, then the format of the secret 60 will always be consistent, irrespective of the identity provider 50 that is used.

Once the identity provider 50 has identified the identity of the party associated with the client 10, the identity provider 50 identifies a predetermined medium for contacting the party associated with the client 10. This predetermined medium is a medium that has been pre-agreed between the identity provider 50 and the party associated with the client 10 and may be, for example, a voice circuit (i.e. a phone call), an SMS channel (carrying, for example, a text message) or a data packet network (carrying, for example, an email). In one example, the identity provider 50 uses the data 40 received from the service provider 20 to derive the predetermined medium for contacting the party from a storage device 115. The storage device 115 stores associations between the party and at least one communication medium that has been previously agreed between the identity provider 50 and the party and that is accessible by the identity provider 50. The storage device 115 may be a component of the identity provider 50, or may be provided by any external storage means that it is accessible by the identity provider 50.

Once the identity provider 50 has identified the predetermined medium for contacting the party associated with the client 10, the identity provider 50 then attempts to contact 70 the party via the predetermined medium and invites the contacted party 80 to identify itself. The identity provider 50 may directly invite the contacted party 80 to identify itself (for example by sending a message 70 to the contacted party 80 that requests the contacted party 80 to identify itself), or the identity provider may indirectly invite the contacted party 80 to identify itself (for example, by sending a message 70 that asks the contacted party 80 to contact the identity provider 50 and then, if the contacted party 80 contacts the identity provider 50, requesting the contacted party 80 to identify itself).

When the contacted party 80 successfully identifies 90 itself to the identity provider 50, the identity provider 50 is configured to determine, up to a predetermined level of trust, whether the identity of the contacted party 80 corresponds to the identity of the party associated with the client 10. The identity provider 50 may, in one example, determine to trust that the contacted party 80 is the party associated with the client 10 if the contacted party identifies 90 itself in accordance with a predetermined set of authentication criteria unique to the associated party. These criteria may require that the contacted party identifies 90 itself via a second predetermined medium. This second predetermined communication medium may be a medium that has been pre-agreed between the identity provider 50 and the party associated with the client 10 and may be different to the first predetermined communication medium. This second predetermined medium may be derived from data accessible to the identity provider 50 from a storage device 115 that stores associations between the party and a number of predetermined communication media. In one example, if the contacted party 80 identifies 90 itself via a medium other than the second predetermined communication medium, the identity provider 50 determines that the identity of the contacted party 50 does not correspond to the identity of the party associated with the client 10. The second communication medium may be, for example, a voice circuit (e.g. a phone call), SMS channel (carrying, for example a text message) or a data packet network (carrying, for example, an email) and is preferably different from the first predetermined communication medium. These predetermined set of authentication criteria may additionally/alternatively require that the contacted party 80 can correctly answer certain questions, the answers to which, are only known by the party associated with the client 10 and the identity provider 50. In general, these authentication criteria are, in themselves, conventional and known. The level of trust to which the identity provider 50 trusts that the identity of the contacted party 80 corresponds to the identity of the party associated with the client 10, depends on how stringent this set of predetermined authentication criteria are. The present invention does not itself limit the level to which the service provider 20 can determine whether to trust the association between the client 10 and the associated party. As an example, if the identity provider 50 determines up to a particular predetermined level of trust, that the contacted party 80 is the party associated with the client 10, then, if the service provider 20 receives a secret from the client 10 that matches the secret that was shared between the service provider 20 and the identity provider 50, then the service provider 20 can also determine up to that same predetermined level of trust that the association between the client 10 and the associated party should be trusted.

If the identity provider 50 determines that the identity of the contacted party 80 corresponds to the identity of the party associated with the client 10, the identity provider 50 then sends a second secret 100 to the contacted party 80. This second secret uniquely corresponds to the first secret 60 that was shared between the service provider 20 and the identity provider 50. If the contacted party 80 (i.e. the party that is associated with the client 10) is the user of the client 10, then the user of the client 10 can provide this secret 100 to the client 10, which can then send data 110 containing the second secret 100 to the service provider 20.

The second secret 100 may, in one example, be sent from the identity provider 50 to the contacted party 80 via a secure channel. The secure channel may be provided, for example, using cryptography. In this case, a cryptographic key will have been pre-negotiated between the contacted party 80 (i.e. the party associated with the client 10) and the identity provider 50.

Upon receipt of data 110 from the client 10 containing a secret, the service provider 20 then compares the secret received in the data 110 to the first secret 60 that was shared between the identity provider 50 and the service provider 20. The service provider 20 knows the level to which the identity provider 50 has determined whether the contacted party 80 is the party associated with the client 10, and has agreed to this level of determination (in one example, the level is pre-agreed between the service provider 20 and the identity provider 50 and in another example, the level is dynamically requested by the service provider 20 based on the type of service requested by the client 10). Therefore, if these two secrets correspond, the service provider 20 determines to trust the client 10. In particular, the service provider 20 determines to trust that the client 10 is authorized to request a service on behalf of the party. The service provider can then provide the requested services to the client 10 using the details 30 (relating to the associated party) provided by the client 10.

In the process described above, details 30 sent by the client 10 to the service provider 20 are those that are required by the service provider 20 to provide a service to the client 10. In an alternative example, the identity provider 50 has access to details relating to the party associated with the client 10 e.g. via the storage device 115. In this example, the identity provider 50 can use the data 40 that identifies the party associated with the client 10 to look up these details, and then send some or all of these details to the service provider 20 via a secure channel. The details that are sent to the service provider 20 may be those that would be required by the service provider 20 to provide a service to the client 10 in the event that the service provider determines to trust that the client 10 is authorized to access a service. For example, if the service provider 20 is providing payment services, the identity provider may send the account details of the party to the service provider 20, and any other details, such as a name and address that may be required to carry out a transaction. Thus, in this example, the client 10 need not send a large number of details 30 to the service provider 20, but is only required to send to the service provider 20 details 30 that are sufficient to identify the identity of the party to the identity provider (once these details have been sent 40 from the service provider 20 to the identity provider 50). This means that a minimal amount of information 30 relating to the party is sent from the client 10 to the service provider 20, reducing the risk that, should the details 30 be intercepted, they can be used fraudulently.

The details 30 may, for example, only identify the party to the identity provider 50 (and could later identify the party to the service provider 20), and may not identify the party to any other entities. As an example, the client 10 may only be required to send the first and last digits of a credit card number, a post code and a day of birth to the service provider 20. The service provider 20 will then send data 40 containing these details 30 to the identity provider 50 (via a secure channel, for example), so that the identity provider 50 can identify the identity of the party. If the details 30 sent between the client 10 and the service provider 20, or the data 40 containing these details sent between the service provider 20 and the identity provider 50, were to be intercepted, these details, in general, could not by themselves be used fraudulently. Thus, in this example, if the service provider 20 determines to trust that the identity of the client 10 corresponds to the identity of the party associated with the client, then the service provider can use the details sent from the identity provider 50 to provide the requested service to the client 10.

In the above processes, the service provider 20 establishes a level of trust with the client 10 through the use of an identity provider 50 and therefore, the identity provider 50 acts as a proxy for the service provider 20. In general, the “identity provider” 50 could be any entity (such as a computing system) that is trusted by the service provider 20 and that knows (or stores/has access to information relating to) the party associated with the client 10. Any such entity is able to act as a proxy for the service provider 20.

Once trust has been established between the client 10 and the service provider 20, the service provider may then provide the service to the client 10 on behalf of the party. This method of establishing trust between the client 10 and the service provider 20 provides several points at which fraudulent activities can be spotted and prevented.

Firstly, if the contacted party 80 is the party associated with the client 10, while the identity of the party is being fraudulently used by/via the client 10, then, upon receipt of the message 70 from the identity provider 50, the contacted party 80 will be alerted to the fact that someone may be trying to fraudulently use their identity. If the contacted party 80 does not respond to the message 70 (by identifying 90 themselves to the service provider 50), the identity provider 50 will also be alerted that the details of the party may be being used fraudulently. Thus, the identity provider 50 will not share the second secret 100 with the contacted party 80, and the client 10 will be unable to provide the correct secret to the service provider 20. Since the service provider 20 will not trust the client 10 if it does not receive data 110 containing a secret corresponding to the first secret 60 from the client 10, then if the contacted party 80 does not identify 90 itself to the identity provider 50, the identity provider 50 may, in one example, be configured to inform the service provider 20 that verification of the identity of the contacted party 80 was unsuccessful. Upon receipt of such a message, the service provider 20 will determine that it cannot trust the client 10, and thus the service provider 20 will refuse to provide services to the client 10.

Secondly, it may be that the first predetermined contact medium between the identity provider 50 and the associated party is somehow compromised. For example, if the identity provider 50 contacts 70 the contacted party 80 via a text message sent to a device associated with the party, the message 70 may be compromised if the device has been stolen or cloned. In this case, if a fraudster attempts to authorize the service requested by the client 10, by identifying themselves 90 to the identity provider 50, the fraudster will, most likely fail the predetermined set of authentication criteria set by the identity provider 50 to determine whether the contacted party 80 is the party associated with the client 10. In this case, the identity provider 50 will not share a second secret 100 with the contacted party 80, and thus the client 10 cannot send the correct secret to the service provider 20. Again, upon determining that the contacted party 80 is not the party associated with the client 10, the identity provider 50 may be configured to indicate to the service provider 20 that verification of the identity of the contacted party 80 was unsuccessful. Upon receipt of such a message, the service provider 20 will determine not to trust the client 10 and will not provide a service to that client 10.

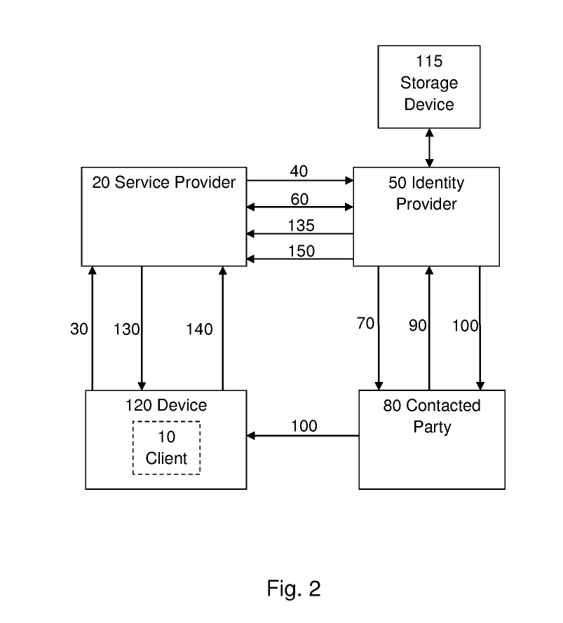

FIG. 2 shows an adaptation of the present embodiment, wherein, the client 10 is an application or program running on a device 120 and the service provider 20 can determine whether to bind the identity of the device 120 to the identity of a party associated with the client 10 in addition to determining whether to trust the client 10.

As in the example above, the client 10, requesting access to services from the service provider 20 on behalf of a party, sends details 30 that identify the party from the device 120 to the service provider 20. In this second embodiment, upon receipt of these details 30, the service provider generates a device identifier 130 that is unique to the device 120, and the service provider 20 stores an association between this unique device identifier 130 and the client 10. The unique device identifier could be a code, password, cryptogram, or number and may be, for example, generated at random by the service provider 20. The service provider 20 then sends this unique device identifier to the device 120 and the device 120 stores the identifier 120 so that the client 10 (or device 120) can identify the device 120 to the service provider 20 at a later time. In an alternative example, the device 120 could generate its own unique device identifier 130, which it may send to the service provider 20. In this case, the service provider then stores an association between the unique device identifier 130 and the client 10. This unique device identifier can again be later used to identify the device 120 to the service provider 20. This unique device identifier 130 may, in one example, be sent automatically by the device 120 when the client 10 sends the details 30 that uniquely identify the party from the device 120. The unique device identifier 130 may, in one example, be formed from hashed values of the CPU (central processing unit) number of the device 120, the GPU (graphics processing unit) number of the device 120, and/or, if the device 120 is a mobile phone, the IMEI (international mobile equipment identity). These details may, in one example, be hashed using a salt value given by the timestamp of the message 30 sent from the client 10 to the service provider 30 identifying a party. Such hashed values are of little use to fraudsters if intercepted. As another example, the unique device identifier could be made up of material stored in a secure element of the device 120.

As in the first embodiment, the service provider 20 needs to determine whether the client 10 is authorized to access a service on behalf of the party and thus again sends data 40 that uniquely identifies the party associated with the client 10 to the identity provider 50. Again, the identity provider 50 acts as a proxy for the service provider 20, which allows the service provider 20 to determine whether to trust the client 10. The identity provider 50 can be any entity that knows (or stores/has access to information relating to) the party that is associated with the client 10 and that is trusted by the service provider 20. As described above, a first secret 60, that is unique to the party associated with the client 10 and is for use by the service provider 20 in determining whether to trust the client 10, is shared between the service provider 20 and the identity provider 60 via a secure channel. Upon receipt of the data 40 identifying the party associated with the client 10, the identity provider 50 uses the process described above to attempt to contact the party associated with the client 10 and to share a second secret 100 that directly corresponds to the first secret with them.

In this second embodiment, if the party associated with the client 10 successfully receives the second secret 100, they can then provide this secret 100 to the client 10. The client 10 then sends data 140 that contains both the second secret 100 and the unique device identifier 130 to the service provider 20. In one particular example, the unique device identifier 130 is automatically sent by the device 120 to the service provider 20 when the client 10 uses the device 120 to send the second secret 100 to the service provider 20 in the data 140. In an alternative example, the client 10 may have access to a number of devices, and the client 10 may send the second secret 100 in data 140 from a different device other than the device 120 associated with the client 10. In this case, the unique device identifier 130 is included by the client 10 in the data 140 that is sent to the service provider 20.

Upon receipt of the data 140 from the client 10, the service provider 20 then determines whether the secret received in the data 140 corresponds to the first secret 60 and also whether the unique device identifier received in the data 140 corresponds to the unique device identifier 130 associated with the device 120. In the event that the service provider 20 determines that the received secret corresponds to the first secret 60 the service provider 20 determines to trust the client 10 (i.e. to trust that the client 10 is authorized to access a service on behalf of the party associated with the client 10). The service provider 20, therefore, forms a trusted association between the client 10 and the party. If the service provider 20 also determines that the received unique device identifier corresponds to the unique device identifier 130 associated with the device 120, the service provider further determines to trust that the party associated with the client 10 is in possession of the device 120, and therefore forms a trusted association between the unique device identifier 130 unique to that device 120 and the identity of the party (and thus, any details held by the service provider 20 relating to the associated party).

In one example, if the service provider 20 forms a trusted association between the device 120 and the party, the service provider 20 binds the identity of the device 120 to the identity of the party associated with the client 10, such that, if the device 120 is later used to gain access to services provided by the service provider 20, the service provider 20 will, in general, trust that the user of the device is the party bound to that device. The service provider 20 may, therefore, allow the client 10 on the device 120 to request services on behalf of the party bound to the device 120 without further authentication checks.

As an alternative, the service provider 20 only trusts that a user of the device 120 (using the client 10 to request a service from the service provider 20) is the party that is bound to the device 120 for services up to a certain value. For services above this value, the service provider 20 may be configured to confirm, using the techniques described above with reference to FIG. 2, that the identity of the user of the device 120 corresponds to the identity of the party bound to the device 120. Additionally or alternatively the service provider 20 may check that the holder/user of the device 120 is the party that is bound to the device after a certain amount of time has elapsed, or after a certain number of services have been requested from device 120, or if the service provider 20 suspects that the device 120 has been compromised.

In the particular example shown in FIG. 2, the identity provider 50 has details relating to the party stored in a storage device 115 accessible by the identity provider 50. As described above, the identity provider 50 uses the data 40 that was sent from the service provider 20 to the identity provider 50 to look up or derive these details from the storage device 115, and then sends some or all of these details 135 to the service provider 20 via a secure channel. The details 135 that are sent to the service provider 20 are those that would be required by the service provider 20 to provide a service to the client 10 in the event that the service provider determines to trust that the client 10 is the party identified in the details. For example, if the service provider 20 is providing payment services, the identity provider may send the account details of the party to the service provider 20, and any other details, such as a name and address that may be required to carry out a transaction. Thus, in this example, the client 10 need not send a large number of sensitive details 30 to the service provider 20, but is only required to send to the service provider 20 details 30 that are sufficient to identify the identity of the party to the identity provider 50 (once these details have been sent 40 from the service provider 20 to the identity provider 50). This eliminates the risk of the details 30 (sent from the client 10 to the service provider) being intercepted and subsequently used fraudulently. In this example, the service provider 20 also binds these details 135 to the device 120 so that if a service is later requested from the device, the service provider 20 does not need to be sent these details again in order to provide the service.

The details 135 could be sent from the identity provider 50 to the service provider 20 at any time after the data 40 (identifying the party associated with the client 10) is sent from the service provider 20 to the identity provider 50.

As described above in relation to the first embodiment, in the event that the identity provider 50 determines that the contacted party 80 is not the party associated with the client, or if the contacted party 80 does not identify 90 itself/refuses to authorize a service on their behalf, the identity provider 50 sends an indication 150 to the service provider 20 that verification of the identity of the associated party was unsuccessful. Upon receipt of such an indication 150, the service provider 20 may stop trusting the association between the client 10 and the party associated with the client 10, and may additionally/alternatively block services to the device 120.

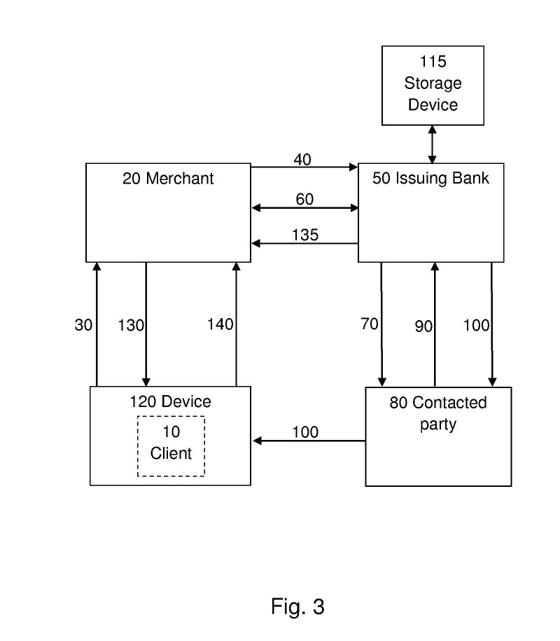

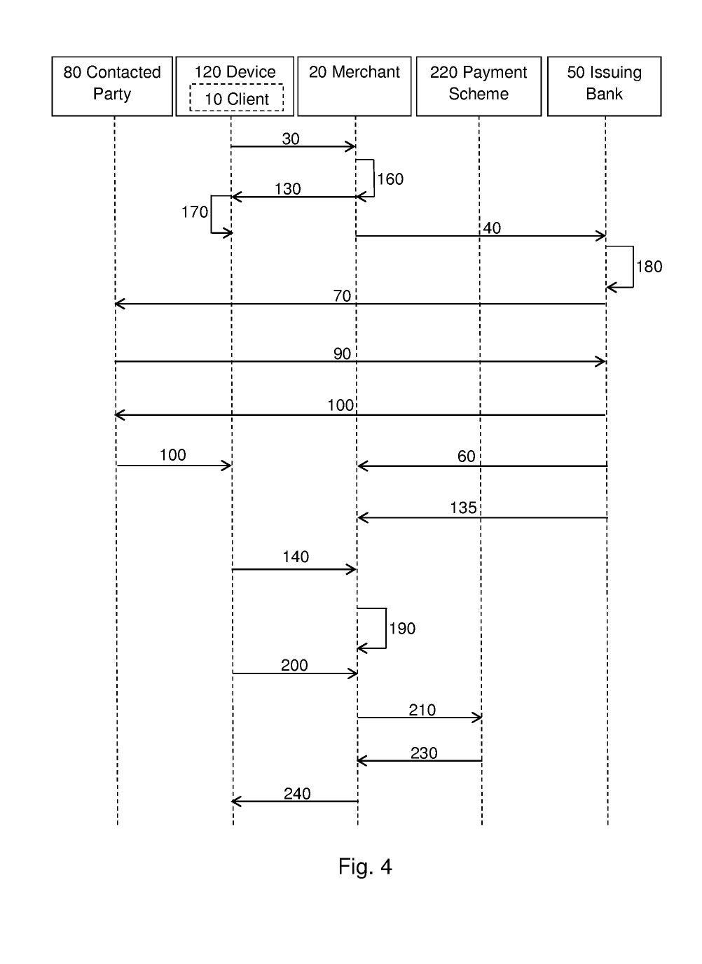

FIG. 3 and FIG. 4 show schematically a particular example of the invention, wherein the service provider is an online merchant 20, which provides online payment services (such as mobile payment services, online wallet services or e-store services) to clients. FIG. 3 illustrates an operating environment, within which the present example may be practiced and FIG. 4 shows a timing diagram of the steps carried out by the various entities involved.

As in the previous examples described with reference to FIG. 1 and FIG. 2, the client 10 requests a service on behalf of an account holder by first sending details 30 to the merchant 20. Such a service may be, in this case, a transaction from the account of the account holder and such details 30, may identify an account of the account holder. In this case, the merchant 20 forms an initial untrusted association between this account and the client 10. In this example, the client 10 is a program or an application on the device 120, and the merchant 20 is configured to determine whether to trust the client 10 and also whether to bind the device 120 to the account (or the account holder) associated with the client 10.

Upon receipt of the details 30 from the client 10 (via the device 120), the merchant 20, at this stage, stores an untrusted association between the client 10 and the account identified by the details 30. The merchant 20 also generates 160 a unique device identifier 130, stores an association between this unique device identifier 130 and the client 10, and then sends it to the device 120, where it is also stored 170, as described above.

The merchant then sends some data 40, which uniquely identifies the bank account associated with the client 10, to an issuing bank 50 (i.e. the identity provider). The issuing bank 50 acts as a proxy for the service provider 20, by performing an authentication process on behalf of the service provider 20, which enables the service provider 20 to determine whether to trust the client 10. In order to act as a proxy, the issuing bank 50 needs to be one that knows (or stores/has access to/can derive) details relating to the account holder and must also be trusted by the merchant 20. In a particular example, the issuing bank 50 is also the bank at which the merchant's bank account is held. The details 40 received by the issuing bank 50 from the service provider 20 can therefore be used to identify the account holder to the bank. The details 40 may be, for example, the first and last digits of a card number associated with the account and the day of birth and postcode of the account holder.

In one example, the issuing bank 50 uses this data 40 to determine the identity of the account holder by using the data 40 to look up the identity of the account holder in a storage device 115 that stores information relating to the account associated with the client 10, and the holder of that account. The issuing bank 50 then generates 180 a secret that is unique to the account holder, and stores an association between this secret and the account holder. In this case, it has been pre-agreed between the issuing bank 50 and the merchant 20 that the issuing bank 50 will generate the secret for the account holder. It will be understood that the secret need not be generated 180 at this stage, but could be generated 180 at a later stage, for example, after the issuing bank 50 has determined whether the identity of the contacted party 80 corresponds to the identity of the holder of the account associated with the client 10. This would avoid secrets being generated unnecessarily if the issuing bank 50 cannot verify that the identity of the contacted party 80 corresponds to the identity of the holder of the account associated with the client 10 or if the issuing bank 50 determines that the identities do not correspond.

The issuing bank 50 also uses the data 40 received from the merchant 20 as described above to identify a predetermined medium for contacting the account holder. In one example, this pre-agreed contact medium may have been agreed between the issuing bank 50 and the account holder when the account holder initially opened the bank account with the issuing bank 50. As an example, the predetermined contact medium may be one that can send a message to a device known by the issuing bank 50 to be owned by the account holder.

Once the issuing bank 50 has identified the predetermined medium for contacting the account holder, the issuing bank 50 attempts to contact 70 the account holder via that predetermined medium. As in the above examples, the issuing bank 50 does not, however, trust that a party 80 in receipt of the communication 70 is the account holder, therefore the initial communication 70 from the issuing bank 50 invites the contacted party 80 to identify itself.

If the contacted party 80 identifies 90 itself to the issuing bank 50, the issuing bank 50 determines up to a predetermined level of trust whether the identity of the contacted party 80 corresponds to the identity of the account holder. As mentioned above, the issuing bank 50 may use a predetermined set of authentication criteria to determine whether the identity of the contacted party 80 corresponds to the identity of the account holder. As a particular example, the set of authentication criteria may require that the contacted party 80 identifies itself using a second predetermined communication channel (which has also been pre-agreed between the account holder and the issuing bank 50) in order for the issuing bank 50 to trust that the contacted party 80 is the account holder. This second predetermined communication channel may also be derived from a storage device 115 accessible by the issuing bank 50, and may be different to the first predetermined communication channel. As a particular example, it may be that it was agreed between the issuing bank 50 and the account holder that, should the issuing bank 50 wish to contact the account holder regarding authorization of payments from their account, the bank will contact the account holder by text, and if the account holder wishes to authorize a payment from their account, the account holder will telephone the bank. Therefore, in this example, the first communication channel is an SMS channel, and the second communication channel is a voice circuit.

The predetermined set of authentication criteria may also require that the account holder correctly answers a number of questions. Such questions may include for example, questions about recent transactions made from the account of the account holder and secret questions pre-agreed between the issuing bank 50 and the account holder (such as, “what is the surname of the person who was your best friend is high school?”).

As in the above examples described with reference to FIG. 1 and FIG. 2, if the issuing bank 50 determines up to a predetermined level of trust that the identity of the contacted party 80 corresponds to the identity of the account holder, the issuing bank 50 sends a first secret 100 to the contacted party 80. Again, this first secret 100 uniquely corresponds to the secret that was generated 180 by the issuing bank 50.

The issuing bank 50 then sends a second secret 60 to the merchant 20, which also uniquely corresponds to the secret generated 180 by the issuing bank 50, via a secure channel. In this example, the issuing bank 50 also sends data 135 containing details relating to the account holder to the service provider 20 via a secure channel. These details 135 are details that would be required by the merchant 20 to make a payment service to/from the account of the account holder. Such details may include, for example, the card number and expiry date of a bank card associated with the account that was identified by the client 10 in the data 30 sent to the merchant 20, and the name and contact details of the account holder.

It will be understood that in general if the identity provider 50 (in this case the bank) generates the secret unique to the party associated with the client 10, the secret 60 can be sent to the service provider 20 (in this case the merchant), at any time after the party has been identified to the identity provider 50, but must be sent to the service provider 20 before the service provider 20 can determine whether to trust the client 10. On the other hand, if the secret unique to the party associated with the client 10 is generated by the service provider 20, then the secret 60 must be sent to the identity provider 50 before the identity provider can share the secret 100 with the contacted party 80.

If the user of the device 120 (on which the client 10 executed) is the contacted party 80 (i.e. the account holder associated with the client 10), then the first secret 100 can be provided to the client 10 and sent in data 140 to the merchant 20. In this example, the data 140 also contains the unique device identifier 130, so that the merchant 20 can determine whether to bind the identity of the device 120 to the identity of the account holder associated with the client 10.

As in the example shown in FIG. 2, upon receipt of the data 140 from the client 10, the merchant 20 then determines whether the secret received in the data 140 corresponds to the first secret 60 and also whether the unique device identifier received in the data 140 corresponds to the unique device identifier 130 associated with the device 120. In the event that the merchant 20 determines that the received secret corresponds to the first secret 60, the merchant 20 determines to trust the client 10 (i.e. to trust that the client 10 is authorized to request a transaction on behalf of the account holder associated with the client 10). The merchant 20, therefore, forms a trusted association between the client 10 and the account holder. If the service provider 20 also determines that the received unique device identifier corresponds to the unique device identifier 130 associated with the device 120, the service provider further determines to trust that the account holder associated with the client 10 is in possession of the device 120, and therefore binds 190 the identity of the device 120 to the identity of the account holder and/or the account held by the account holder and also binds the identity of the device 120 to the details 135 (that relate to the account holder) that were sent from the issuing bank 50 to the merchant 20. In the present example, now that the merchant has bound 190 the device 120 to the account (that was originally identified 30 to the service provider 20 by the client 10), the merchant 20 only requires the unique device identifier 130 of the device 120 in order to identify the account bound to the device and thus to provide services to the client 10 on behalf of the account holder.

At some time later, the client 10 sends a request 200 to the merchant 20 to carry out a transaction. The request 200 includes a transaction amount and also the unique device identifier 130 of the device 120. Upon receipt of the unique device identifier 130, the merchant 20 identifies the device 120, and thus the account associated with this device 120 (because the account is associated with the device 120). The merchant also derives the details 135 relating to the account and the account holder bound to the device 120 from the unique device identifier 130. The merchant 20 then sends data 210 containing these details 135, and also the transaction amount received in the request 200, to a payment scheme 220. The request 200 is subsequently processed by the payment scheme in accordance with conventional methods, which are outside of the scope of the invention. Briefly, the payment scheme 220 coordinates authorization of the transaction, which is to say, it checks the account holder has sufficient funds to cover the transaction and if the funds are sufficient, sends an indication 230 to the merchant 20, so that the merchant 20 can complete the service 240.

As mentioned above, in one example, it may be that the merchant 20 only trusts that a user of the device 120 (using the client 10 to request a transaction from the merchant 20) is the holder of the account associated with the device 120 for transactions up to a certain limit. For transactions above this limit, the merchant 20 may be configured to confirm that the identity of the user of the device 120 corresponds to the identity of the holder of the account associated with the device 120 using the techniques described above with reference to FIG. 2.

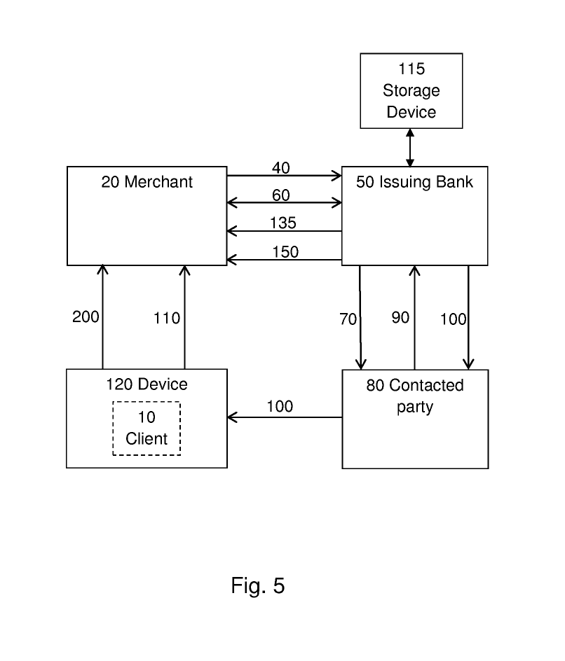

FIG. 5 shows a block diagram of a particular example of one such method. In the example shown, the device 120 is bound to an account held by an account holder associated with the client 10 running on the device 120. At the time that the device 120 was bound to the account, it was determined by the merchant 20 that the user of the device 120 was the account holder. The client 10 running on the device 120 sends a request 200 to a merchant 20 to carry out a transaction from/to the account associated with the device. The request 200 contains the unique device identifier 130 of the device 120 and also specifies a transaction amount. In this example, the transaction amount is above a predetermined upper limit and thus the merchant 20 is triggered to check whether the user of the device is the holder of the account bound to the device 120 (that is to say, whether the client 10 on the device 120 is still authorized to request a transaction on behalf of the holder of the account bound to the device 120). The merchant 20, therefore, uses the unique device identifier 130 to identify the device 120 and thus the associated account that is bound to the device 120. The merchant 20 also uses this unique device identifier 130 to look up details 135 that relate to the account associated with the device 120 and that were stored by the merchant 20 during the registration process. The transaction limit could be unique to the account bound to the device 120, and in this case, the merchant 20 will only be triggered to authenticate the user of the device 120 once the merchant 20 has identified the account bound to the device 120 from the unique device identifier 130. In general, the limit may, for example, have been set by the merchant 20, the account holder or the issuing bank at which the account is held.

The merchant 20 then uses these details 135 to send data 40 that identifies the account associated with the device 120 to an issuing bank 50 that is trusted by the merchant 20 and which knows the holder of the account associated with the device 120 so that the issuing bank 50 can act as a proxy for the merchant 20 to enable the merchant 20 to determine whether to trust the client 10 according to any of the processes described above.

In this example, if the issuing bank 50 does not trust that the identity of the contacted party 80 (that was contacted via a predetermined medium identified from the data 40 sent from the merchant 20) is the same as the identity of the account holder bound to the device 120 (whether this is because the contacted party 80 did not attempt to identify 90 itself, because the contacted party 80 denied the request for a transaction on their behalf, or because the contacted party 80 did not meet the predetermined authentication criteria set by the issuing bank 50), then the issuing bank 50 sends an indication 150 to the merchant 20 that verification was unsuccessful. Upon receipt of this indication 150, the merchant 20 may unbind the device 120 from the account holder with which the device 120 was initially associated. The merchant 20 may additionally block the device 120 from further services with the merchant 20.

The particular process outlined above (i.e. the determination of whether the user of the device 120 is the holder of the account bound to the device 120), is triggered if the client 10 requests a transaction above a certain threshold; however, the method may also be triggered for other reasons, for example, the merchant 20 may check whether the user of the device 120 is the holder of the account bound to the device 120 after a certain amount of time has elapsed, or after a certain number of transactions have been made using the device 120, or, more generally, if the merchant 20 suspects that the device 120 may have been compromised. In another example, the issuing bank 50 may suspect fraudulent activities from the account associated with the device 120, and may, for example, notify the merchant that a check on the identity of the holder of the device 120 should be carried out.

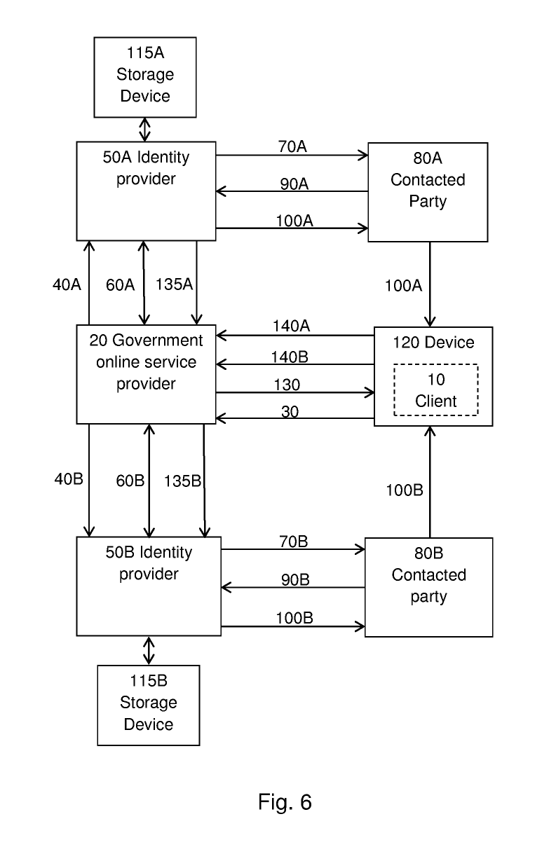

FIG. 6 shows a further example of an embodiment of the present invention, wherein the service provider 20 is a government online service provider, which may provide, for example, services such as benefits payments, police enquiry services, border control services, passport services etc. As in the previous examples, the client 10, via the device 120, requests a service from the government online service provider 20 on behalf of a citizen. In this example, the government online service provider 20 is configured to determine whether to trust the client 10 and also whether to bind the identity of the citizen to the identity of the device 120. The client 10 first sends details 30 from the device 120 to the government online service provider 20 that uniquely identify the citizen. As for the foregoing embodiments, the government online service provider 20 stores an untrusted association between the client 10 and the citizen, and also an association between a unique device identifier 130, unique to the device 120, and the client 10.

In this embodiment, the citizen is known by two identity providers 50A,50B, which are both trusted by the government online service provider 20 and can, thus act as independent proxies for the government online service provider 20 by enabling the government online service provider 20 to determine whether to trust the client 10 and resultantly, whether to bind the device 120 to the citizen. In this example, the identity providers 50A,50B may be, for example, government servers that store details relating to the citizen; health care providers with which the citizen is registered; insurance companies with which the citizen is registered, or police servers storing details relating to the citizen.

In this case, two different first secrets 60A,60B, that are both unique to the citizen associated with the client 10 are shared between the identity providers 50A,50B and the government online service provider 20. Each of the identity providers 50A,50B independently attempt to share second secrets 100A,100B, that each correspond to a different one of the first secrets 60A,60B for the identity providers 50A,50B, with the citizen according to the processes outlined above. Thus, in this case, the government online service provider 20 only determines to trust the client 10 if the client 10 provides data 140A,140B containing two secrets that each correspond to a different one of the first secrets 60A,60B for the two identity providers 50A,50B.

If the secrets correspond, and if the data 140A,140B also contains a unique device identifier that corresponds to the unique device identifier 130 associated with the device 120, then the government online service provider 20 further determines to bind the identity of the device 120 to the identity of the citizen associated with the client 10 as explained above.

It will be understood that in any of the examples outlined above, a service provider 20 can use a plurality of identity providers 50 to determine to trust a client 10 of the service provider 20. In this case, the service provider 20 will share a different first secret 60 with each of these identity providers 50, and the service provider will determine to trust the client 10 if the client 10 sends the service provider 20 a plurality of secrets, each of which correspond uniquely to a different one of the first secrets 60 shared between the service provider 20 and the identity providers 50. The greater the number of independent identity providers 50 used by the service provider 20, the greater the level of trust to which the service provider 20 can trust the client 10 and thus a plurality of identity providers 50A,50B can, in general, be used when a high level if identity assurance is needed by the service provider 20.

It will also be understood by a person skilled in the art, that a number of the steps outlined above can be combined or can have their order modified. For example, if the service provider 20 generates a secret 60 that is unique to the party associated with the client 10, the service provider can send data containing both details identifying the party and the generated secret 60 to the identity provider at the same time.

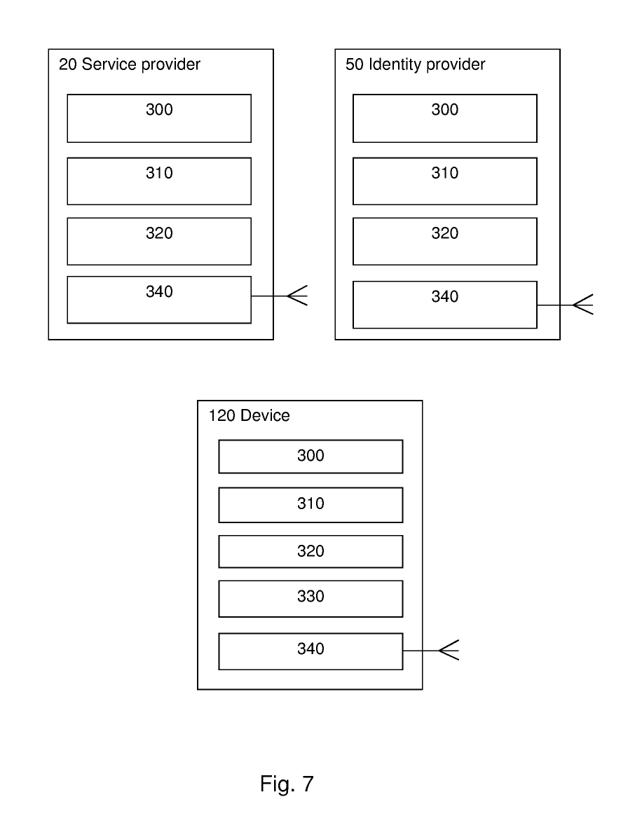

FIG. 7 shows schematically components of exemplary computing devices configured to execute any of the exemplary embodiments as described above. The device 120 is provided by a computing device comprising processor 300, a non-volatile storage device 310 (such as a hard disk drive and/or non-volatile memory such as a so-called solid state disk for example) and a random access memory (RAM) 320. The processor 300 processes instructions stored in the random access memory 320 that have been loaded from the non-volatile storage device 310. These instructions are in the form of computer software in the form of one or more applications. In particular, such applications include the client application 10. Applications running on the processor 300 also process user input obtained from a user interface 330, whether via a touch screen and/or keyboard, etc. The user interface 330 can be used by the user of the device 120 to provide details identifying a party to the client application 10 running on the device 120, and also to input the second secret 100. The device 120 also includes a network interface 340 (or a plurality of such interfaces) which allows applications running on the processor 300 to transmit and receive data to and from other devices and systems via a communications network (or a plurality of such networks), via wired and/or wireless connections. In particular, the network interface 340 is for use in communicating with the service provider 20. The device 120 may also optionally have a trusted execution environment (i.e. a secure element), where, for example, the unique device identifier 130 can be encrypted, cryptographic keys can be stored and information can be signed. Such a secure element is, in one example, accessible to the client application 10.

The service provider 20 is also provided by a computing device comprising processor 300, a non-volatile storage device 310 (such as a hard disk drive and/or non-volatile memory such as a so-called solid state disk for example) and a random access memory (RAM) 320. The processor 300 processes instructions stored in the random access memory 320 that have been loaded from the non-volatile storage device 310. These instructions are in the form of computer software in the form of one or more applications. Such applications may, for example, generate a secret 60 that is unique to the party associated with the client 10 running on the device 120 or, as another example, compare a secret received from the device 120 to a secret stored in the non-volatile storage device 310. The secret received from the device 120 may be encrypted, and thus may need to be decrypted before it can be compared to the secret stored in the non-volatile storage device 310. The non-volatile storage device 310 may store data relating to the client application 10 running on the device 120 and the party associated with the client application 10 (such data may include, for example, the identity of the party a secret associated with the party and the identity of the device 120 associated with the client 10). The service provider computing device 20 also includes a network interface 340 (or a plurality of such interfaces) which allows applications running on the processor 300 to transmit and receive data to and from other devices and systems via a communications network (or a plurality of such networks), via wired and/or wireless connections. In particular, the network interface 340 is for use in communicating with the device 120 and also the identity provider 50. The service provider 20 computing device may optionally also comprise a hardware security module (HSM), which may store encryption keys and may be used to decrypt received encrypted data. The HSM may also be used to generate a secret 60 that is unique to the party associated with the client 10 running on the device 120.

The identity provider 50 is similarly provided by a computing device comprising processor 300, a non-volatile storage device 310 (such as a hard disk drive and/or non-volatile memory such as a so-called solid state disk for example) and a random access memory (RAM) 320. The processor 300 processes instructions stored in the random access memory 320 that have been loaded from the non-volatile storage device 310. These instructions are in the form of computer software in the form of one or more applications. Such applications may, for example, determine whether the identity of an identifying party 80 corresponds to the identity of the party associated with the client 10 running on the device 120. The non-volatile storage device 310 may, for example, store data relating to the party associated with the client application 10 running on the device 120 and in particular, may store data from which, a predetermined medium for contacting the party can be determined and also from which, it can be determined whether the identity of an identifying party corresponds to the identity of the party associated with the client 10 running on the device 120. The identity provider computing device 50 also includes a network interface 340 (or a plurality of such interfaces) which allows applications running on the processor 300 to transmit and receive data to and from other devices and systems via a communications network (or a plurality of such networks), via wired and/or wireless connections. In particular, the network interface 340 is for use in communicating with the service provider 20 and also possibly for contacting the party associated with the client 10 running on the device 120. The identity provider 50 computing device may optionally also comprise a HSM, which may store encryption keys and may be used to decrypt received encrypted data. The HSM may also be used to generate a secret 60 that is unique to the party associated with the client 10 running on the device 120.

In many of the examples described above, the client 10 is an application or a program running on a device. It will be understood, however, that the role of the client 10 can be filled, for example, by a person using a device and claiming to a service provider 20 to have the identity of a party. In this case, the methods outlined above can be used to determine whether the identity of the client 10 corresponds to the identity of the party, or whether the client 10 is fraudulently using the details of the party.

The above embodiments are to be understood as illustrative examples of the invention. Further embodiments of the invention are envisaged. For example, the secret 60 that is shared between the service provider 20 and the identity provider 50 may have been generated by the service provider 20, and may have been prepositioned in a secure environment of the device 120, the secure environment being an environment that is not accessible by the client 10 running on the device 120. In this case, if the user of the device provides a secret 100, that has been received from the identity provider 50, to the client 10 running on the device 120 the client 10 can, in turn, share this secret 100 with the device 120. The device 120 may then determine whether the secret 100 provided by the client 10 matches the secret 60 that is stored on the device. If the secrets match, the device 120 may allow the client 10 (and therefore the user of the device 120) to access services on the device 120 if the secrets match. This may be useful, for example, if the device 120 contains secret/sensitive documents, which should only be accessed by certain people. In this case, the device 120 is, in essence, part of the service provider 20 and the service provider 20 regulates access to the secret/sensitive documents on the device. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of establishing trust between a service provider and a client of the service provider, the client being associated with a party known by an identity provider that is trusted by the service provider, and said identity provider using a predetermined medium to contact said party, the method comprising:
contacting the party via said predetermined medium, whereby to request the party to identify itself to the identity provider;
determining, up to a predetermined level of trust, whether the identity of the identifying party corresponds to an identity held by the identity provider for the party;
sharing a first secret with the party in the event that the identity provider has determined that the identity of the identifying party is the same as said identity held by the identity provider, said first secret being for use by the client in establishing trust between the client and the service provider.

2. A method according to claim 1, further comprising receiving data that uniquely identifies the party, and using this data to identify both the identity of the party and said predetermined medium for contacting the party.

3. A method according to claim 2, further comprising identifying said predetermined medium from a storage device accessible by the identity provider, said storage device storing associations between said party and at least one communication medium previously agreed between the identity provider and said party.

4. A method according to claim 3, wherein in the event that the identity provider verifies that the identity of the identifying party does not correspond to an identity held by the identity provider for the party, then the identity provider indicates to the service provider that verification was unsuccessful.

5. A method according to claim 4, wherein the party is known by a plurality of identity providers, each of which is trusted by the service provider and in which, in the event that each said identity provider independently determines that the identity of the identifying party corresponds to the identity of the party, each of said identity providers shares a different first secret with the party, each said different first secret being for use by the client in establishing trust between the client and the service provider.

6. A method according to claim 2, wherein said data is sufficient for the party to be identified by the identity provider, but is insufficient for a transaction to be carried out using the data.

7. A method according to claim 5, wherein the step of determining whether the identity of the identifying party corresponds to an identity held by the identity provider for the party is dependent upon the identifying party identifying itself in accordance with a predetermined set of authentication criteria.

8. A method according to claim 7, wherein, for each identity provider, the method further comprises sharing a second secret unique to that identity provider between that identity provider and the service provider for the party via a secure channel.

9. A method according to claim 8, wherein trust is established between the client and the service provider in dependence upon the first secret for each identity provider matching the second secret for that identity provider.

10. A method according to claim 9, wherein at least one identity provider sends data relating to the party to the service provider, said data being required by the service provider to provide a service to the client.

11. A method according to claim 10, wherein, for each identity provider, the first secret for that identity provider is shared with the party contacted by that identity provider via a secure channel.

12. A method of establishing trust between a service provider and a client of the service provider, the client being associated with a party known by an identity provider that is trusted by the service provider, said identity provider using a predetermined medium to contact said party thereby requesting said party to identify itself and, in the event of the identity provider determining up to a predetermined level of trust that the identity of the identifying party corresponds to the identity of said party, said identity provider sharing a first secret with said party, the method comprising:
sharing a second secret with the identity provider; and,
responsive to receipt of a secret from the client, determining whether the secret received from the client matches said second secret; and,
in the event that the secret received from the client matches said second secret, determining to trust said client.

13. A method according to claim 12, further comprising receiving data from the client that uniquely identifies the party and sending said data to the identity provider.

14. A method according to claim 13, wherein said data is sufficient for the party to be identified, but is insufficient for a transaction to be carried out using the data.

15. A method according to claim 14, wherein the party is known by a plurality of identity providers, each of which is trusted by the service provider and in which each of said identity providers shares a different second secret with the service provider, each said different second secret being for use by the service provider in establishing trust between the client and the service provider.

16. A method according to claim 15, wherein the service provider receives data relating to the party from at least one identity provider, said data being required by the service provider to provide a service to the client.

17. A method according to claim 16, wherein said client is further associated with a device and, in the event that a secret that matches said second secret is received from the client in association with data that uniquely identifies a said device, the method further comprises:
determining whether the device identified by said data corresponds to said associated device; and,
in the event that the device identified by said data corresponds to said associated device, binding the identity of the device to the identity of said party.

18. A method according to claim 17, wherein, in the event that a message is received from the identity provider that indicates that the service provider was unable to verify the identity of the party, further services with said device are blocked.

19. A system for use in establishing trust between a service provider and a client of the service provider, the system comprising:
a service provider computing system; and
a proxy computing system associated with a proxy acting for the service provider, said proxy being trusted by the service provider and said client being associated with a party that is known by the proxy, wherein said proxy computing system is arranged to contact said party using a predetermined medium, the proxy computing system being arranged to:
contact the party via said predetermined medium, whereby to request the party to identify itself to the proxy;
determine, up to a predetermined level of trust, whether the identity of the identifying party corresponds to an identity held by proxy for the party; and
responsive to a determination that the identity of the identifying party corresponds to said identity held by the proxy, share a first secret with the party, and
responsive to receipt of a secret from the client, the service provider computing system is arranged to determine whether the secret received from the client matches said first secret, and, in the event that the secret received from the client is determined to match the first secret, the service provider computer system is arranged to configure a level of trust in respect of said client for the service provider.

20. A system according to claim 19, wherein the service provider computing system is arranged to send data that uniquely identifies the party to the proxy computing system, and the proxy computing system is arranged to use this data to identify both the identity of the party and said predetermined medium for contacting the party.

21. A system according to claim 20, wherein said data is sufficient for the party to be identified by the proxy computing system, but is insufficient for a transaction to be carried out using the data.

22. A system according to claim 21, wherein the proxy computing system is arranged to identify said predetermined medium using a storage device accessible by the proxy computing system, said storage device being arranged to store associations between said party and at least one communication medium previously agreed between the proxy and said party.

23. A system according to claim 22, wherein the system comprises a plurality of proxy computing systems, each of which is associated with a proxy acting for the service provider, each said proxy being trusted by the service provider and knowing said party,
wherein each of the plurality of proxy computing systems is arranged such that, in the event that each said proxy computing system independently determines that the identity of the identifying party corresponds to the identity of the party, each of said proxy computing systems is arranged to share a different first secret with the party, each said different first secret being for use by the client in establishing trust between the client and the service provider.

24. A system according to claim 23, wherein the proxy computing system is arranged to determine whether the identity of the identifying party corresponds to an identity held by the proxy computing system for the party in dependence upon the identifying party identifying itself in accordance with a predetermined set of authentication criteria.

25. A system according to claim 24, wherein the system is arranged to share a respective second secret between each proxy computing system and the service provider computing system via respective secure channels, each said second secret being unique to a respective said proxy computing system for the party.

26. A system according to claim 25, wherein the service provider computer system is arranged to establish trust between the client and the service provider in dependence upon the first secret for each proxy matching the second secret for the plurality of proxy computing systems.

27. A system according to claim 26, wherein the proxy computing system is arranged to send data relating to the party to the service provider, said data being required by the service provider to provide a service to the client.

28. A system according to claim 27, wherein said client is further associated with a device and, in the event that a secret that matches said second secret is received from the client in association with data that uniquely identifies a said device, the service provider computing system is further arranged to:
determine whether the device identified by said data corresponds to said associated device; and,
in the event that the device identified by said data corresponds to said associated device, bind the identity of the device to the identity of said party.

29. A system according to claim 28, wherein each proxy computing system is arranged such that, in the event that a proxy computing system determines that the identity of the identifying party does not correspond to an identity held by the identity provider for the party, said proxy computing system is arranged to send an indication to the service provider computing system that verification of the identity of the party was unsuccessful and, responsive to receipt of a said indication, the service provider computing system is arranged to block said device from further services associated with the service provider.

30. A system according to claim 29, wherein, for each proxy computing system, the first secret for that proxy computing system is shared with the party contacted by that proxy computing system via a secure channel.
